(19) United States
(12) Patent Application Publication
(10) Pub. No.: US 2008/0249871 A1
(43) Pub. Date: Oct. 9, 2008

(54) System and Method for the Advertising, Marketing and Sale of Real Estate

(75) Inventor: Jack B. Kornovich, Spring Lake Park, MN (US)

Correspondence Address: DYKAS, SHAVER & NIPPER, LLP, P.O. BOX 877, BOISE, ID, 83701-0877, US

(73) Assignee: CheapHousePayments.com, Inc., Boise, ID (US)

(21) Appl. No.: 11/868,867

(22) Filed: Oct. 8, 2007

Related U.S. Application Data
(60) Provisional application No. 60/828,545, filed on Oct. 6, 2006.
(60) Provisional application No. 60/891,292, filed on Feb. 23, 2007.

(51) Int. Cl. G06Q 20/00; G06Q 30/00

(52) U.S. Cl. 705/14; 705/80; 705/39

(57) ABSTRACT

The invention is a system and method for the advertising, marketing and sale of property, such as real estate. In one version, the system/method operates on the principle of having the builder (and other parties) prepay a sum of money to be held by a facilitator (or another party) in trust. Over the first eighteen to twenty-four months of the property purchaser's mortgage, a predetermined portion of the proceeds of this trust is paid back to the property purchaser to assist (payment assistance program) the purchaser in making his/her mortgage payments. The result is that the effective mortgage payment amount of the purchaser/buyer is reduced for the first eighteen to twenty-four months, an incentive for the buyer to buy a home sold via the invented method.

### CROSS-REFERENCE TO RELATED APPLICATIONS

This application claims priority from provisional patent application No. 60/891,292, filed Feb. 23, 2007, entitled “System and Method of Leveraging Real Estate Appreciation in the Advertising, Marketing and Sale of Real Estate” and also claims priority from provisional patent application No. 60/828,545, filed Oct. 6, 2006, entitled “System and Method for the Advertising, Marketing and Sale of Real Estate,” the disclosures of which are incorporated herein by reference.

### FIELD OF THE INVENTION

The present invention generally relates to methods of doing business, and more particularly to a method and system for the advertising, marketing and sale of property, including but not limited to automobiles and real estate.

### DESCRIPTION OF THE PREFERRED EMBODIMENTS

While the invention is susceptible of various modifications and alternative constructions, certain illustrated embodiments thereof will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description, like elements are identified with like reference numerals. The use of “or” indicates a non-exclusive alternative without limitation unless otherwise noted. The use of “including” means “including, but not limited to,” unless otherwise noted.

The invention is a system and method (hereinafter collectively “method”) for the advertising, marketing and sale of property.

One embodiment of the method operates on the principle of having the home builder (and possibly other parties) prepay a sum of money to a facilitator to be held in trust. Generally, over a predetermined period of time (e.g., the first eighteen to twenty-four months) of the property purchaser's mortgage, a predetermined portion of this trust is paid back to the property purchaser to assist (via the “Payment Assistance Program”) the purchaser in making his/her mortgage payments. The result is that the effective mortgage payment amount of the purchaser/buyer is reduced for that period of time, an incentive for the buyer to buy a home sold via the invented method, resulting in an incentive for other parties (sellers, builders, etc.) to participate as well.

Should the buyer sell its property before the end of the predetermined period of time, upon confirmation that the lender has been paid in full, the facilitator would issue a check for the balance of any funds held in trust on the buyer's behalf directly to the buyer. Likewise, should the buyer die before the end of the program and the loan is (through insurance or other proceeds) paid in full, the facilitator would issue a check for the balance of the funds held in trust directly to the deceased buyer's estate/spouse.

At the end of the Payment Assistant Program schedule (the predetermined period of time) the facilitator will cease sending checks to the buyer to assist with its mortgage payments and the home owner will need to make its entire mortgage payment on its own. Optionally, the buyer may decide to refinance with a cooperating mortgage company to reenroll in another Payment Assistant Program (if available). Another option (if available) might be for the buyer to sell the property using the facilitator and the method (including the Payment Assistant Program) in order to sell the home more quickly and help another buyer to achieve affordable housing.

The money held in trust can come from a variety of sources. The facilitator's professional team of negotiators could secure savings with everyone involved in the process of building and selling a home. For example, they might secure savings with lumberyards, land developers, real estate agents and individual home sellers that are passed onto the seller/developer, savings which reduce the builder's effective cost of doing business. This savings enabling the parties and/or facilitator to pass the savings on to the buyer, in the form of lower monthly house payments.

The embodiment could also utilize a web site for the use of the parties to the transaction. This web page could also serve as a location where the properties are advertised. A prospective buyer, in visiting the facilitator's designated website and finding a property he/she was interested in, would be given the seller (builder's) contact information to set up a showing and/or prepare a purchase and sale agreement. The website could likewise provide for the advertising of rental and/or lease-only properties.

In one example, upon successful closing of a transaction, the facilitator is paid an advertising fee by the seller (builder). This advertising fee, minus the facilitator's administrative fees, is deposited into an account (held in trust, preferably by a third party (trustee)). A monthly check using funds from that account is sent out to the buyer (purchaser) made out to the buyer alone or both the buyer and the buyer's mortgage lender which is then used by the buyer to effectively lower the buyer's monthly house payment.

These savings are negotiated for the buyer by the negotiators/facilitator at no additional cost to the buyer. However, as is customary, the buyer may be required to pay certain closing costs that are normally assessed against the buyer in a typical real estate transaction. The buyer may also be required to make a down payment (depending on the buyer's choice of financing).

The facilitator will optionally have one or more cooperating mortgage companies that buyers can contact. It is preferred and encouraged that buyers use these cooperating mortgage companies. The ability to take advantage of the method's “Payment Assistance Program” may even be contingent upon using a cooperating mortgage broker and escrow/title company, where allowed by law.

A prospective individual home owner wishing to sell (“for sale by owner”) their home through use of the method can do so through the facilitator's “for sale by owner” portion of the website. Such a seller would need to provide all necessary information in order to list the property and be willing to pay an advertising fee to the facilitator at closing, the advertising fee to be used by the facilitator (less administrative expenses) to enroll the buyer in the Payment Assistant Program.

Upon successful closing of the real estate transaction, the funds that were negotiated discounts by the facilitator (minus an administrative fee) are placed into an escrow account with an account number assigned to each customer (buyer). On a predetermined schedule (day of the month) a predetermined amount from the escrow account (via check) is sent to the buyer may be is made jointly payable to the buyer and the buyer's lender. The buyer would then merely need to endorse the back of the check and send it in to its lender, along with a check for the remaining balance of its full mortgage payment. The pre-determined amount the facilitator sends to the buyer is based on whether the buyer chose an 18-month or 24-month Payment Assistance Program (or other term).

The Payment Assistance Program will preferably have program guidelines that must be followed. For instance, the buyer may be required to make all of its payments on time, and if the facilitator is ever notified by the lender that buyer's mortgage payments are late the full amount of the funds remaining in the account assigned to the buyer will be automatically surrendered. These surrendered funds, for instance, could be forwarded to the lender with the mortgage default.

This method has a number of advantages to the home purchaser, the builder, the investor, the mortgage lender, the seller, and other parties.

Purchaser's Advantage. The advantage to the purchaser in the utilization of the invented method is easy to see, in that the purchaser is able to purchase the same home for the same price (as if they would have purchased the method through a traditional real estate transaction), but their effective monthly payment will be but a fraction of what the monthly payment actually is. The difference between the actual mortgage payment amount and the effective mortgage payment amount is money which the purchaser can reincorporate into his/her budget, using such amount to pay down debt, pay down their mortgage, or use for other expenses.

If, rather than using the invented method, the seller of the property instead merely reduced the price of the property by an equivalent amount, the savings (on the actual monthly mortgage payments) for the buyer wouldn't be anywhere as large as would be the savings using such a method.

Another benefit to the purchaser is it allows them to (presuming the house appreciates in value) quickly generate equity in a property while making low payments on it. Additionally, when the buyer assistance ends and they personally have to start making full mortgage payments on their own, they could examine the possibility of selling their home and buying a new one, or locking in a new mortgage using the invention's method, thereby perpetually maintaining extremely affordable effective mortgage payments.

Builder Advantage. In today's volatile real estate market builders have no certainty of sales when it comes to new homes. A home builder's main goal is to provide quality housing at affordable prices. Unfortunately that is the same goal the builder's competition is also striving to achieve. However, using the present invention, builders are more likely to sell their houses quickly because the houses are more appealing to buyers due to the lower effective mortgage payment.

The builder also benefits from the facilitator's use of a team of professional negotiators who go out and negotiate savings on the builder's behalf with vendors, subcontractors and other parties. The negotiators work with everyone from land developers to lumberyards and all the subcontractors in between. The goal of the negotiation is to work as a team, everyone pitching in to come up with a dollar amount of savings. Once that dollar amount is determined, that savings is paid to the facilitator as an advertising fee at the property's closing. The facilitator setups an account with those funds and sends monthly payments to the buyer to apply toward their mortgage payment.

Optionally, builders can be given, by the facilitator, a login and password to access the facilitator's website. On this site they could see all the savings that have negotiated exclusively for the program's builders.

Mortgage/Lender Advantages. Mortgage lenders will be recruited into the network, through paying advertising fees or other revenue into the trust, in order for them to be a member of the network and accrue all of the benefits thereto, including the ability to use any related logos, trademarks and other good will, just as the builders and other participants may be able to. Prospective buyers will, via the web site, be provided with means for contacting cooperating lenders to acquire their lending services.

Seller Advantage. The method provides a number of advantages for sellers as well. For instance, most properties are listed by a real estate company who charges a fee to sell the home. This fee could be as high as 10% of the sales price, plus most offers that are made on properties tend to be 3%-5% below the asking price. Thus, it is not uncommon for a property to net 13-17% below asking price considering these factors. Through using the disclosed method, these fees are eliminated and instead the seller pays an advertising fee to the facilitator, a fee that will still leave them better off than they would be in a traditional mortgage arrangement.

A second embodiment of the present invention could be used in automobile financing. In one version of such an embodiment, the facilitator will contract with an auto seller (dealer, franchiser and other retailer, including consumer auto, RV, marine, recreational vehicles, etc.), wherein they (auto seller) will pay the facilitator an advertising or program-participation fee. That fee can be funded by factory rebates, dealer incentives, etc. (collectively referred to as “dealer incentives”). From facilitator's ad revenue, or from the funds received as part of the program-participation fee, facilitator will establish an escrow account (again, managed by a third-party escrow service) to hold funds for the benefit of the buyer. Facilitator will pay the buyer from the escrowed funds every month for a predetermined amount of time, for instance twelve months for an automobile. The payment the facilitator provides effectively reducing the buyer's net auto payment. Various renditions of this concept, including elements of other embodiments within this description, could supplement this automobile financing concept.

In a third embodiment of the present invention, provided is an “Appreciation Plus” system. The Appreciation Plus system uses the previously discussed Payment Assistance Program, but runs for a longer period of time and provides buyers with lower monthly payments, more protection from payment shock and more insulation from market fluctuations.

One sub-embodiment of the Appreciation Plus system works as follows. The facilitator will contract with the seller of property to receive an advertising or marketing fee in exchange for the facilitator's unique advertising services. Once the facilitator has the property “under contract ” the facilitator will advertise that property on the facilitator's website and/or through other manners. Prospective buyers can visit the facilitator's website, hear about the facilitator's services through word of mouth, etc. When a buyer finds a home he/she likes, the buyer can then contract with the facilitator to participate in the program.

The buyer will negotiate the final purchase price with the seller, and the two will enter into a purchase/sale agreement. At closing, the seller pays to the facilitator its advertising/marketing/facilitation/funding fee (hereinafter “advertising fee”). The facilitator will then take the advertising fee and will put a predefined percent or portion of it into a third-party escrow account for the buyer's benefit. The remaining portion serving as at least some of the facilitator's compensation (“participation fee” or “administrative fee”) for facilitating the transaction.

Once a month (or on another predetermined schedule), for a predetermined amount of time (for instance, twenty-four (24) months), the buyer will receive a check (or other financial transfer) from the escrow account which will effectively reduce the buyer's effective (net) monthly mortgage payment. These checks are made payable to the buyer or jointly to the buyer and the buyer's lender or service or are otherwise handled to maintain the financial obligations and security of the method.

After the predetermined amount of time (i.e., twenty-four months), the buyer has benefited from lower net monthly payments, and the property has, at the same time, appreciated in value. At the end of the predetermined amount of time (i.e., twenty-four months), a pre-determined amount of equity is “taken ” from the property and rolled back into the escrow account. In other words, the principal amount of the loan, which has been decreasing over the last period of time (i.e., twenty-four months), is increased by a certain amount, and that amount (less a participation fee for the facilitator) is deposited back into the escrow account.

Then, for a second predetermined period of time (i.e., twenty-four months), the buyer will again receive payments every month which will effectively reduce the buyer's net monthly mortgage payment. Because the amount of contribution back into the program is less than the historical average real property appreciation, the loan-to-value ratio actually stays below 100%. For example, if a buyer started with a 100% loan-to-value ratio, at the end of year two the buyer could have an 82% LTV (because of property appreciation at an average of 6%, plus a pay down of principal over those two years). Then, at the end of year two (or other period of time), a portion of that equity (for instance, five percent (5%) would be rolled back into the escrow account. However, because that portion (i.e., five percent) is a less than the historical average real property appreciation (i.e., six percent), the LTV after year two will be around 95%, while at the same time, the buyer will benefit from another predetermined period (i.e., two years) of payment assistance.

This process can then repeat itself regularly (as desired) for ten years (or another period). In summary, every two years (or other predetermined period) the principal amount of the mortgage loan will be increased to fund the Payment Assistance Program account/fund, which will in turn be used to help lower the buyer's monthly mortgage payment. As the buyer continues to pay down his/her principal and appreciation occurs, the loan to value ratio will continue to benefit the buyer and protect the lender's security. At the end of ten years (in this example), the loan to value could be around 68%.

### EXAMPLE

A property is listed at $225,000, which is the market value of that property. A borrower wants to use the Appreciation Plus system and obtains a 100% loan-to-value mortgage (i.e., borrows $225,000). The mortgage is actually divided into two loans, a first mortgage of 80% LTV and a second loan of 20% LTV. Total payment due on these loans (with 6% and 10% APR respectively) for principal and interest is $1,474.10. A total of $20,505.00 is put into the Payment Assistance Program fund, which will pay out $854.38 per month for two years, effectively reducing the borrower's monthly payment to $619.73.

At the end of two years, the property is worth $254,004.00, considering an “average” property value appreciation. That means after accounting for principal payments for the last 24 months, there is $34,088.00 in equity. $18,699.03 is taken from this equity amount and put back into the Payment Assistance Program fund, leaving a new LTV of about 95%. The key here (in this particular example) is that each new 2 year period has a slightly lower contribution, so the buyer's payments for each new 2 year period will rise slightly so as to avoid payment shock that would otherwise come from a large adjustment. The buyer's principal amount borrowed has gone up because of the new contribution to the Payment Assistance Program fund, so now the borrower owes $241,026.00 as his principal amount. Even though this is more than the original amount borrowed, it is less than the value of the property due to appreciation. For the next two years then, the buyer's usual payment would be $1,573.34 but with the Payment Assistance Program, the buyer's net payment is really $794.21. As you can see, the $794.21 per month due the second two years is only slightly higher than the $619.73 per month due the first two years.

This process can repeat itself every two years, so that during the last two years (years 9 and 10), the buyer owes a principal amount of $287,794.00 and the buyer's usual payment would be $1,868.03 with a net payment of $1,072.63. Even though the principal amount has increased, the buyer has benefited from lower monthly payments and has experienced no payment shock for ten years (because the increases are relatively minor each two year period), all the while the property has appreciated at a higher rate and therefore the buyer could end up with property worth $412,546.00 but owing only $280,405.00, which leaves the buyer with over $130,000.00 in equity and the borrower has been benefiting from reduced monthly payments the whole time.

Any of the various steps in embodiments of the present invention could be performed through use of a client computer configured to interact with the server computer via a communications network such as the Internet or a Local Area Network (LAN).

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the description of the preferred embodiments is to be regarded as illustrative in nature, and not as restrictive in nature.

The exemplary embodiments described above illustrate but do not limit the invention. It should be understood that there is no intention to limit the invention to the specific form disclosed; rather, the invention is to cover all modifications, alternative constructions, and equivalents falling within the spirit and scope of the invention as defined in the claims. For example, while the exemplary embodiments illustrate a method of advertising, marketing and selling real estate, the invention is not limited to use with real estate and may be used with other items, properties and materials. While the invention is not limited to use with the advertising, marketing and sale of property, it is expected that various embodiments of the invention will be particularly useful with such subject matter.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

What is claimed is:

1. A method for the facilitation of the sale of a piece of property, said method comprising the steps of:
(a) negotiating a sale price for said piece of property between a buyer and a seller;
(a) collecting from the seller of the piece of property a predetermined amount of legal tender to be held in trust;
(b) financing the purchase of said property through a lender thereby resulting in a financed amount;
(c) selling the property to a buyer; and
(d) said facilitator paying a predetermined percent of said predetermined amount of legal tender towards said financed amount.

2. The method of claim 1, wherein said property is a piece of real property.

3. The method of claim 1, wherein said predetermined amount of legal tender is a percent of the sales price of the piece of property.

4. The method of claim 1, wherein said property is an automobile.

5. The method of claim 4, wherein said predetermined amount of legal tender includes dealer incentives.

6. The method of claim 1, wherein said predetermined amount of legal tender is a flat fee.

7. The method of claim 1, wherein the predetermined percent of said predetermined amount of legal tender is divided generally equally into a plurality of payments, said payments paid on a regular schedule over a term towards said financed amount.

8. The method of claim 1, wherein said predetermined percent of said predetermined amount of legal tender is paid jointly to one or both of said buyer and said lender.

9. The method of claim 1, further comprising the step of the buyer providing a service to the facilitator in exchange for the seller paying a predetermined percent of said predetermined amount of legal tender towards said financed amount.

10. A method for the facilitation of the sale of a piece of property for sale by a seller, said method comprising the steps of:
(a) a seller agreeing to pay a facilitator a predetermined amount of legal tender to be held in trust;
(b) a buyer financing the purchase of said property through a lender thereby resulting in a financed amount;
(c) upon the sale of said property to said buyer, said seller paying said predetermined amount of legal tender to said facilitator; and
(d) said facilitator paying a predetermined percent of said predetermined amount of legal tender towards said financed amount.

11. The method of claim 10, wherein said property is a piece of real property.

12. The method of claim 10, wherein said predetermined amount of legal tender is a percent of the sales price of the piece of property.

13. The method of claim 10, wherein said predetermined amount of legal tender is a flat fee.

14. The method of claim 10, wherein the predetermined percent of said predetermined amount of legal tender is divided generally equally into a plurality of payments, said payments paid on a regular schedule over a term towards said financed amount.

15. The method of claim 14, wherein said payments towards said financed amount are paid jointly to said buyer and said lender.

16. The method of claim 14, wherein said payments towards said financed amount are paid to said lender.

17. The method of claim 14, wherein said payments towards said financed amount are paid to said buyer.

18. The method of claim 10, further comprising the step of said facilitator advertising said property for sale.

19. The method of claim 10, further comprising the step of the buyer providing a service to the facilitator in exchange for the seller paying a predetermined percent of said predetermined amount of legal tender towards said financed amount.

20. A method of leveraging real estate appreciation in the sale of a piece of real property, said method comprising the steps of:
(a) negotiating a sale price for said piece of property between a buyer and a seller;
(b) collecting from the seller of the piece of property a predetermined amount of legal tender to be held in trust in a trust account thereby resulting in a trust account balance;
(c) financing the purchase of said property thereby resulting in a financed amount;
(d) selling the property to a buyer;
(e) paying down said financed amount through regular payments from said trust account balance;
(f) paying down said financed amount through making regular mortgage payments;
(g) waiting a predetermined period of time for said piece of property to increase in value;
(h) appraising said piece of property to determine an appraised value;
(h) subtracting the current financed amount from said appraised value to determine a buyer's equity in said piece of property;
(i) refinancing said piece of property and transferring a percent of said equity into said trust account; and
(j) repeating steps (e)-(i) after additional predetermined periods of time.

21. The method of claim 20, wherein said predetermined amount of legal tender is a percent of the sales price of the piece of real property.

22. The method of claim 20, wherein said predetermined amount of legal tender is a flat fee and a percent of the sales price of the piece of real property.

23. The method of claim 20, wherein the predetermined percent of said predetermined amount of legal tender is divided generally equally into a plurality of payments, said payments paid on a regular schedule over a term towards the financed amount.

24. The method of claim 23, wherein said regular schedule is monthly.

25. The method of claim 23, wherein said term is between twelve and forty-eight months.
